(19) United States
(12) Patent Application Publication
(10) Pub. No.: US 2026/0143361 A1
(43) Pub. Date: May 21, 2026

(54) SELF-HEALING NETWORK FUNCTIONS FOR CELLULAR NETWORKS

(71) Applicant: DISH Wireless L.L.C., Englewood, CO (US)

(72) Inventors: Abhishek Jayprakash Shirke, Aurora, CO (US); Mohammad Dawood Shahdad, Aurora, CO (US); Prakashkumar M. Patel, Castel Rock, CO (US)

(21) Appl. No.: 18/952,152

(22) Filed: Nov. 19, 2024

(51) Int. Cl. H04W 24/04; H04W 24/02

(52) U.S. Cl. CPC H04W 24/04; H04W 24/02

(57) ABSTRACT

Technologies for providing self-healing of functions of a cellular network are described. One method includes obtaining first error codes associated with one or more operations of a first network function of a cellular network. The method further includes providing the first error codes as input to a first trained machine learning model. The method further includes obtaining, from the first trained machine learning model, first predictive output based on the first error codes. The method further includes performing a first corrective action in view of the predictive output.

### BACKGROUND

Telecommunication networks, such as cellular networks, have various resources that produce data and metadata concerning operations of the cellular network. A customer, such an enterprise customer, of a cellular network does not have access to the data and metadata generated by the network resources of the cellular network. Status reports, including error codes, may be generated which are indicative of deficiencies in operations of the network.

One type of cellular network is a Fifth generation (5G) wireless network. In a 5G wireless network, a 5G Standalone Core Network (5G SA core) is responsible for managing and routing data traffic, providing various network resources and services, and supporting the core functionalities of a 5G network. The term “SA” stands for “Stand-Alone,” indicating that this core network operates independently of any existing 4G (LTE) infrastructure. 5G wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times. A control plane may include a part of a network that controls how data packets are forwarded or routed. The control plane may be responsible for populating routing tables or forwarding tables to enable data plane functions. A data plane (or forwarding plane) may include a part of a network that forwards and routes data packets based on control plane logic. Control plane logic may also identify packets to be discarded and packets to which a high quality of service should apply. 5G wireless user equipment (UE) may communicate over both a lower frequency Sub-6 GHz band between 410 MHz and 7125 MHz and a higher frequency mmWave band between 24.25 GHz and 52.6 GHz. As described above, various resources and services of the 5G wireless network are not accessible to a customer for optimizing usage and configuration of these resources in a meaningful and insightful way.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of self-healing cellular network system, according to some embodiments.

FIG. 2 is a block diagram depicting operations of a self-healing network system, according to some embodiments.

FIG. 3 depicts a cellular network including a radio access network and a core network configured to generate predictive data for self-healing of network functions, according to some embodiments.

FIG. 4 depicts a radio access network and a core network for providing a communication channel between user equipment and a data network, including a self-healing component, according to some embodiments.

FIG. 5 illustrates a model training workflow and model application workflow for cellular network data in connection with self-healing operations, according to some embodiments.

FIG. 6 is a flow diagram of a method for performing corrective actions based on network function error codes, according to various embodiments.

### DETAILED DESCRIPTION

Technologies for providing self-healing capabilities to functions of a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

There are new and emerging applications with time sensitive features that could provide significant improvements to operations of a wireless network. However, as described above, a network operator (e.g., a user) may not have an ability to reliably and quickly obtain, analyze, utilize, or perform adaptations based on diagnostic data received from the network. The network operator may receive the data and metadata generated by the resources of the cellular network, but without the ability to quickly, efficiently, or effectively enact updates to improve network performance. Further, a network function may be unequipped to perform operations locally for improving network performance. A significant cost in terms of data transfer, time delay, extended time of non-optimal network conditions, etc., may be incurred by configuring network functions to be updated based on a central control system, rather than local control updates. Conventionally, there are no mechanisms to enable a self-healing of network functions, or local control providing updates to a configuration of network resources in the cellular network.

Aspects and embodiments of the present disclosure address the above and other deficiencies by providing a self-healing platform that may provide customized responses or actions to improve operations of a cellular network. In some embodiments, a cellular network may include a number of probes for measuring various conditions of the network. The probes may be designed, selected, generated, installed, etc., by one or more designers, engineers, or other personal associated with physical and/or digital architecture of the cellular network, e.g., customers or consumers of the cellular network may not be involved in implementation of probes for measuring conditions of the network.

Probe data provided may include error codes associated with operations of one or more network functions of the cellular network. Error codes may include errors related to operations of the function, and/or communication interfaces of the network function, such as hypertext transfer protocol (HTTP) error codes, session initiation protocol (SIP) error codes, diameter result codes, etc.

Error codes of network functions may report on various properties of the network, including data flow properties, connectivity properties, radio characteristics, or the like. Error codes may be provided from various components of a cellular network, including network functions such as a policy control function, network repository function, session management function, network slice selection function, authentication server function, network exposure function, access and mobility management function, user plane function, or the like. In some systems, a central server, central component, central unit, or the like may be configured to adjust aspects of the network based on error codes. In such a system, one or more updates to operations of a cellular network (e.g., in relation to error codes generated by network functions) may not be immediately available for implementation. For example, the network may be configured for a central management system to make updates to network operations, such as routing or rerouting network traffic, and a local system may be unable to quickly make updates to improve operations of a particular network function, communication interface, or the like.

In conventional systems, processing of error data may be performed at a location separated from data generation architecture. For example, a central processing system (e.g., a cloud-based processing system, remote virtual machine, or the like) may be utilized for receiving error code data, and generating actionable data for improvement of the cellular network. Such systems suffer from high costs of data transport, including architecture, bandwidth constraints, data and equipment management concerns, etc. Such systems further may suffer from data quality, e.g., data logs may be collected or aggregated by one or more pieces of equipment, equipment of one or more vendors, equipment located at one or more locations, etc., and separation, identification, tagging, etc., of this data may be complex. Further, such operations may be prone to the introduction of various errors or data decorations that inhibit the analysis of the data, in particular subject matter expert independent, or subject matter expert supervised, analysis. For example, analysis that proceeds independent of human intervention, or largely independent of human intervention, may be difficult or impossible based on log data generated, collected, and aggregated in such a way.

In some embodiments, a self-healing component may be provided to one or more network functions of a wireless network. The self-healing component may perform a series of operations to obtain log data (e.g., error code data), and provide actionable data (e.g., summary data, insight data, corrective action data, etc.) for performance by the network function associated with the self-healing component. The actionable data may be generated using a rule-based model, statistical model, heuristic model, trained machine learning model, or the like.

In some embodiments, edge computing devices (e.g., devices physically close to regions where various operations of the network are performed) may be utilized to execute one or more network functions including self-healing components. The edge computing devices may be installed proximate equipment associated with the network functions. In some embodiments, and edge computing device may exchange data with a radio unit (RU), a DU, a CU, or the like, for example based on availability of access to the various components, proximity to a data collection facility, or the like. In some embodiments, a computing device that executes a network function may also execute a self-healing component of the network function for agile updating of operations of the network function, or the like. In some embodiments, error codes may instead or additionally be provided to a central function (e.g., a central control function), which may enable enacting corrective actions. A central function, central component, central unit, or the like may enact corrective actions for network errors that are associated with operations of multiple network functions, for example.

In some embodiments, providing error codes to a model of a self-healing component may be performed responsive to an error code being generated, e.g., related to operations of a network function, a communication interface of the network function, or the like. In some embodiments, providing error codes to a model of a self-healing component of a network function may be performed responsive to a number of errors being generated, e.g., in a target period of time. In some embodiments, multiple time periods with multiple thresholds of error generation may be provided. For example, a high spike of error frequency in a short duration of time may trigger providing error codes to a self-healing component model, or a somewhat lower frequency of errors in a longer duration of time may also trigger providing error codes to the self-healing component model. Multiple thresholds may be defined, each associated with a different period of time, duration, or the like. In some embodiments, additional data may also be provided to the model, e.g., contextual data, etc.

In some embodiments, a self-healing component of a network function may enact corrective actions to improve performance of the cellular network. For example, a self-healing component may perform or cause to be performed corrective actions including rerouting network data traffic (e.g., to avoid an error-prone communication interface or malfunctioning network function or piece of network equipment), deregistering one or more network functions (e.g., to trigger all traffic to avoid the deregistered function), bypassing one or more network functions, or providing the error data, including connectivity and/or communication error data, to a centralized control function.

Aspects and embodiments of the present disclosure can provide a self-healing capability to network functions executed in connection with the cellular network. Aspects and embodiments of the present disclosure can enable network applications to leverage open radio access network (O-RAN) centric wireless networks to ensure reliable/improved service for verticals such as health care, Vehicle-to-Everything (V2X), Extended Reality (XR), immersive applications, or the like. V2X is a term used in the automotive and transportation industry to describe communication technology that allows vehicles to communicate with various elements of the surrounding environment. This includes communication between vehicles (V2V), between vehicles and infrastructure (V2I), between vehicles and pedestrians (V2P), and more. V2X technology is designed to enhance road safety, traffic efficiency, and overall transportation systems by enabling vehicles to share information about their status, location, and intentions with other vehicles and infrastructure. XR is a term that encompasses virtual reality (VR), augmented reality (AR), mixed reality (MR), and other immersive technologies that combine the physical and digital worlds to create immersive and interactive experiences. These technologies are used in various applications, including gaming, training and simulation, healthcare, education, architecture, and more. The self-healing systems can collect data and provide network updates as a real-time correction of the cellular network to the network functions and application. The various applications can use the real-time measurement context of the cellular network for dynamic control of one or more resources or services of the cellular network.

Aspects and embodiments of the present disclosure can provide applications with time sensitive features with agile control, improvement, and consistent operation of the cellular network, without the complications of data analysis, transport, and storage of large volumes of data, as edge computing devices close to data generation or aggregation sites may perform much of the workload of data analysis operations and enacting of corrective actions.

It should be noted that 5G and emerging 6G network architectures are based on the concept of virtual network functions and cloud native network functions. Aspects and embodiments of the present disclosure can cause the virtual network functions and/or cloud native network functions to perform self-healing operations in the cellular network and interact with additional embedded artificial intelligence/machine learning (AI/ML) inferences, e.g., for generating predictive data of corrective actions to be performed by the network functions.

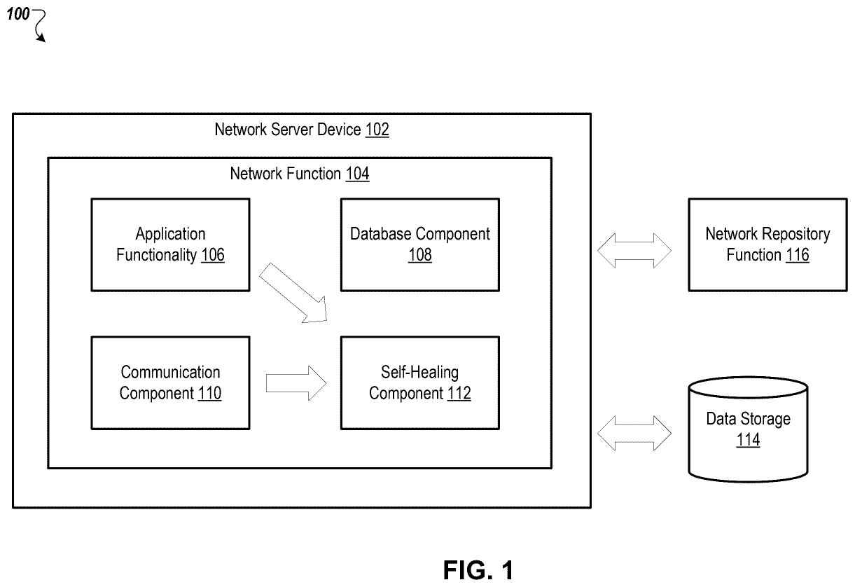

FIG. 1 is a block diagram of a self-healing cellular network system (self-healing system 100) including self-healing component 112, according to some embodiments. Self-healing system 100 includes network server device 102 and data storage 114. Functions of these devices may be performed by or include one or more processing devices, memory banks, network connections, input/output devices, etc. Devices performing functions of self-healing system 100 may include one or more general purpose computing device, purpose-built computing devices, customized controllers, desktop computers, personal computers, laptop computers, mobile phones, tablets, programmable processing devices or controllers, single-purpose hardware, or the like. Data storage 114 may include any device for storing and accessing data, including non-transitory machine-readable storage media, optical memory, magnetic memory, flash memory, hard drives, or any other type of data storage that may be applicable to operations of self-healing system 100. Self-healing system 100 may include edge computing devices, e.g., computing devices physically located proximate one or more cellular network components of a cellular network associated with self-healing system 100. Self-healing system 100 may include any number of devices, e.g., many server devices including network server device 102, many data storage devices including data storage 114, etc. In some embodiments, operations ascribed to one device may be performed by another device, including a virtual machine or cloud-based computing platform. Operations of network function 104 may be enacted by one or more computing devices, represented in FIG. 1 by network server device 102.

Network function 104 may be any network function of a cellular network that may benefit from self-healing functionality. Network function 104 may be or include a network slice selection function (NSSF), e.g., a function responsible for selecting an appropriate network slice for a user, service, group of users, function or facility, or the like. The NSSF may determine an appropriate network slice for a user or request based on user capabilities, current network conditions, etc. The NSSF may ensure that a selected network slice meets required policies and service quality. The NSSF may coordinate with other network functions to facilitate establishment and management of network slices.

Network function 104 may be or include an authentication server function (AUSF). The AUSF may be responsible for authenticating users, subscribers, user equipment, and the like to ensure accurate and secure access to network services. The AUSF within a cellular network (e.g., a 5G core network) may ensure that legitimate users can access network services. The AUSF may support various authentication methods for different types of user equipment, etc.

Network function 104 may be or include unified data management (UDM). The UDM may be responsible for managing subscription data. The UDM may store and manage subscription data, user profiles, subscription information, etc. The UDM may support authentication and authorization processes by providing subscriber data to other network functions, such as the AUSF. The UDM may interact with a policy control function (PCF) to apply policies based on subscriber status. The UDM may support mobility management by providing data to an access and mobility management function (AMF) or other network functions.

Network function 104 may be or include a network exposure function (NEF). A network exposure function may be responsible for exposing network capabilities and services to external applications and services, e.g., through well-defined application programming interfaces (APIs) or other applicable communication interfaces. The NEF may perform data filtering and transformation to improve data quality and ensure authorized data is exposed to external applications. The NEF may orchestrate interactions between network functions and external applications.

Network function 104 may be or include a network repository function (NRF). In some embodiments, data generated by self-healing component 112 may be provided to an NRF, e.g., when network function 104 is a network function different than the NRF. The NRF allows different network functions to register their services and capabilities. This may include providing information about the services offered by the network functions and the interfaces (e.g., communication interfaces) the network functions support. The NRF may enable various network functions to discover and communicate with each other. The NRF may responds to requests from various network functions requesting services or functionality, providing details of network functions that may provide the requested services. The NRF may maintain and provide status information about network functions, including availability and load.

Network function 104 may be or include an access and mobility management function (AMF). The AMF manages tasks related to access and mobility of user equipment. The AMF may handle registration of user equipment. The AMF may manage establishment, maintenance, and release of connections for user equipment via the cellular network, including handovers as user equipment moves between geographical regions served by different radio units. The AMF may be involved in and/or support authenticating user equipment to ensure secure access to the network, e.g., in cooperation with the AUSF. The AMF may perform functions to locate and connect user equipment to the network when required, e.g., when a phone receives a call. The AMF may interact with radio units to manage and control radio resources.

Network function 104 may be or include a session management function (SMF). The SMF may manage functions related to sessions of user equipment connectivity to the cellular network. The SMF may establish, modify, and release session. The SMF may allocate IP addresses and manage session states. The SMF may enforce policies related to service quality and traffic routing. The SMF may coordinate with the policy control function to apply network policies based on subscription information and network conditions. The SMF may interface with the user plane function to manage data forwarding and routing, and ensure data packets are properly routed and delivered via the cellular network. The SMF may support creation and management of network slices.

Network function 104 may be or include a policy control function (PCF). The policy control function may manage policy decisions and enforce policies. The PCF may enforce policies related to network resource usage, quality of service, subscription access, etc. The PCF may interact with other network functions to provide policy decisions that guide the handling of sessions, mobility events, and other network activities.

Network function 104 may be or include any of these functionalities, or others that may be of interest in pairing or augmenting with a self-healing component, e.g., self-healing component 112. Network function 104 may include multiple components, e.g., application functionality 106, database component 108, communication component 110, and self-healing component 112. Application functionality 106 may include operations associated with normal performance of functions of the network function 104, e.g., functions of the various network functions described in the previous paragraphs. Database component 108 may perform operations associated with storage and recovery of data for network function 104. Communication component 110 may manage communication interfaces, e.g., between the network function and other network functions, between the network server device 102 and other devices of the cellular network, or the like.

Self-healing component 112 may obtain data from other components of the self-healing cellular network system 100 for performance of operations related to improving the cellular network. Self-healing component 112 may obtain, from other components of the network function 104, one or more inputs for providing recommendations, generating predictive data, and/or initiating corrective actions. For example, from application functionality 106, self-healing component 112 may obtain status reports indicating errors in performance of network function operations. Data provided to self-healing component 112 from application functionality 106 may include error codes. Data provided to self-healing component 112 from application functionality 106 may include connectivity checks, health check, infrastructure checks (e.g., related to network server device 102 and/or data storage 114), etc. Data provided to self-healing component 112 from communication component 110 may include error codes from one or more communication interfaces utilized by network functions 104 to exchange information with other components of the cellular network. For example, communication component 110 may provide HTTP status codes, SIP error codes, diameter result codes, or data related to other communication interfaces of the network function 104. Self-healing component 112 may obtain the data (e.g., error codes) from the other components of network function 104 and generate predictive, analytic, and/or corrective data based on the data provided to self-healing component 112.

In some embodiments, self-healing component 112 may perform one or more corrective actions based on data provided by other components of network function 104. Self-healing component 112 may cause one or more actions based on output of a model included in self-healing component 112, e.g., a trained machine learning model configured to output recommended corrective actions. The self-healing component 112 may cause traffic or data from network function 104 to be rerouted, to bypass one or more other network functions, to bypass one or more pieces of network equipment, to provide connectivity to a central control function or another network function (e.g., network repository function 116), or the like.

In some embodiments, data generated by self-healing component 112 may be provided to network repository function 116. Network repository function 116 may perform operations based on the data provided by self-healing component 112, e.g., corrective actions. For example, error codes may be interpreted by self-healing component 112 (e.g., by a trained machine learning model included in self-healing component 112) as indicating that one or more communication interfaces, network functions, network components (e.g., radios, computing devices, distributed or central units, or the like) may be inoperable, damaged, or otherwise not meeting performance thresholds. The network repository function 116 may perform one or more corrective actions based on the self-healing component 112 data, e.g., rerouting some or all network traffic away from a component or network function, deregistering a network function, responding to service requests to indicate that one or more network services are offline, or the like.

Operations of self-healing system 100 may be utilized in cellular networks, 5G networks, emerging 6G networks, or other types of networks including various network functions that may benefit from self-healing operations. Any communication models in accordance with third generation partnership project (3GPPP) standards for mobile networks may utilize aspects of the present disclosure for self-healing functions. Cellular network operations performed in cloud environments, core network functionality, edge computing devices, or the like may each incorporate self-healing components. Each of the data provided to self-healing component 112 may be provided as a micro-service related to a potential network error source. Self-healing component 112 may be provided data based on both service-based interfaces and point-to-point interfaces of the network. A self-healing component may be utilized on public, private, or hybrid network environments, including cloud network environments.

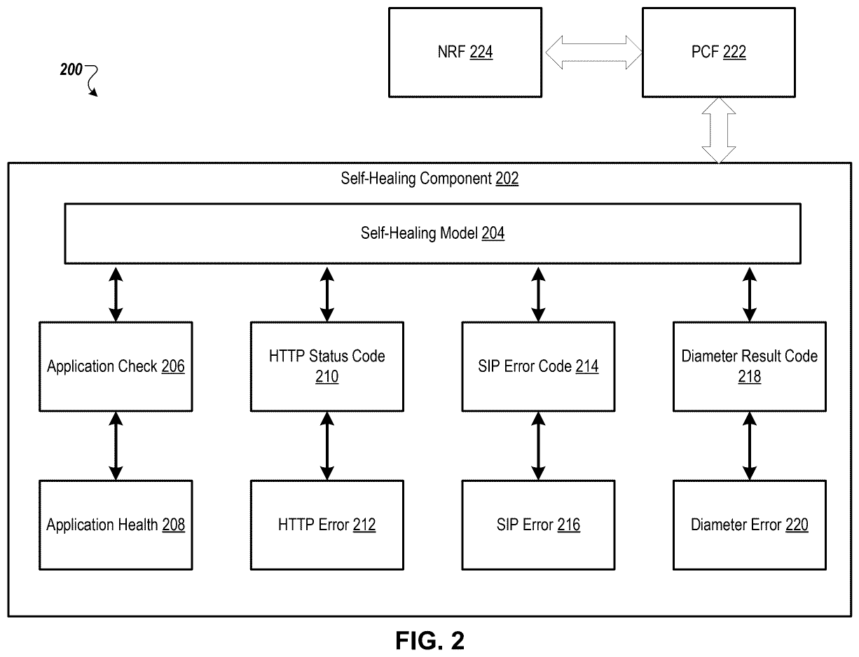

FIG. 2 is a block diagram depicting operations of self-healing network system 200, according to some embodiments. Self-healing component 202 may be included in any applicable network function, e.g., may share one or more features with self-healing component 112 of FIG. 1. Self-healing component 202 includes self-healing model 204, which may obtain input data and generate predictive output data, e.g., indicative of recommended corrective actions to perform performance of the cellular network.

Self-healing model 204 may be or include a rule-based model, e.g., a model including pre-programmed responses to various inputs. Self-healing model 204 may be or include a statistical model. Self-healing model 204 may be or include a trained machine learning model. self-healing model 204 may be configured to obtain indications of network health and/or network function performance, and generate predictive data based on the input.

Application check 206 may provide status updates based on application health 208. Application health may include any indications of whether the network function is performing as intended. Application health may include connectivity reports. Application health may include results of reachability tests. Application health 208 may include health checks to ensure the network function is operating correctly. Application health 208 may include infrastructure checks, e.g., to ensure various components of the cellular network associated with the network function are operating in accordance with specifications. Application check 206 may provide one or more status indicators, error codes, or the like to self-healing model 204 based on application health 208. In some embodiments, application check 206 may be relevant for many and/or any type of network functions included in a cellular network.

Data indicative of HTTP interface error 212 may be provided as an HTTP status code 210 to self-healing model 204. An HTTP error 212 may include a client error, e.g., related to a status code with a 4xx designation. A 4xx HTTP status code 210 may indicate that a request includes improper syntax or otherwise cannot be fulfilled. A 4xx HTTP status code 210 may be provided to self-healing model 204, which may generate a predictive action based on the HTTP status code 210 and other inputs, including other error codes, other result codes, context/meta data, and the like. An HTTP error 212 may include a server error, e.g., related to a status code with a 5xx designation. A 5xx HTTP status code 210 may indicate that a server failed to fulfil a request, which may indicate failure of a network component, network function, network interface, or the like. The HTTP status code 210 may further be provided to self-healing model 204 for generation of predictive data. In some embodiments, an HTTP status code 210 may be provided to self-healing model 204 for network functions which communicate via an HTTP interface.

Occurrence of one or more session initiation protocol (SIP) errors 216 may result in SIP error code 214. SIP error code 214 may share one or more features with HTTP status code 210, e.g., the SIP error code 214 may be indicative of a mode of failure of an SIP communication interface. The SIP error code 214 may be provided to self-healing model 204. The SIP error code 214 may be provided for network functions which utilize SIP communication.

Data indicative of a diameter error 220 may be provided to self-healing model 204 as diameter result code 218. Diameter is an authentication, authorization, and accounting protocol that may be used for communication of a network function. Diameter result code 218 may be or include a code indicating a mode of failure of a diameter interface. Diameter result code 218 may be provided as input to self-heling model 204, which may in turn generate predictive data for performance of corrective actions to improve operation of the cellular network.

Each of application check 206, HTTP status code 210, SIP error code 214, and diameter result code 218 may be considered to be micro services, provided within the network function for generation of predictive data. Based on the type of network function, various micro services may be included, enabled, etc. HTTP status codes may be available for service based interfaces, e.g., access and mobility functions, short message service functions, unified data repositories, or the like. SIP error codes may be available for IP multimedia subsystem functions, e.g., access session border control functions, interconnect session border control functions, etc. Diameter result codes may be utilized for functions that utilize diameter protocol for data communication.

In some embodiments, self-healing model 204 may perform a corrective action by providing information to a separate network function, e.g., PCF 222, NRF 224, or the like. In some embodiments, traffic may be rerouted to a different communication interface to reach a target network function, a network function exhibiting comparable functionality being executed on a different device, or the like. In some embodiments, updates may be provided to PCF 222, which may enforce new policies based on output of self-healing model 204, e.g., avoiding one or more pieces of equipment or network functions. In some embodiments, PCF 222 may provide data to NRF 224, which may for example reroute traffic away from a malfunctioning component, deregister one or more network functions, register one or more network functions, update status such as maximum bandwidth or traffic capabilities of one or more components of the network, or the like.

In some embodiments, self-healing model 204 may be a rule-based model, e.g., it may be provided with one or more programmed outputs based on received error codes. In some embodiments, self-healing model 204 may be or include a trained machine learning model. In some embodiments, self-healing model 204 may be implemented as a rule-based model, and may be configured to receive updates to adjust parameters of the model. Self-healing model 204 may be implemented as a machine learning model with initial training parameters (e.g., input by one or more subject matter experts) that are allowed to be updated based on feedback. For example, a reduction in error codes, a change in error codes, feedback based on improved network performance, or the like may be provided to self-healing model 204 to retrain the model, update the model, improve performance of the model, etc. Feedback may be input by a user, automatically provided based on network probe data or error codes, or the like. In some embodiments, output of self-healing model 204 may further be provided to a central control function, e.g., for performance of more global updates based on status and error codes.

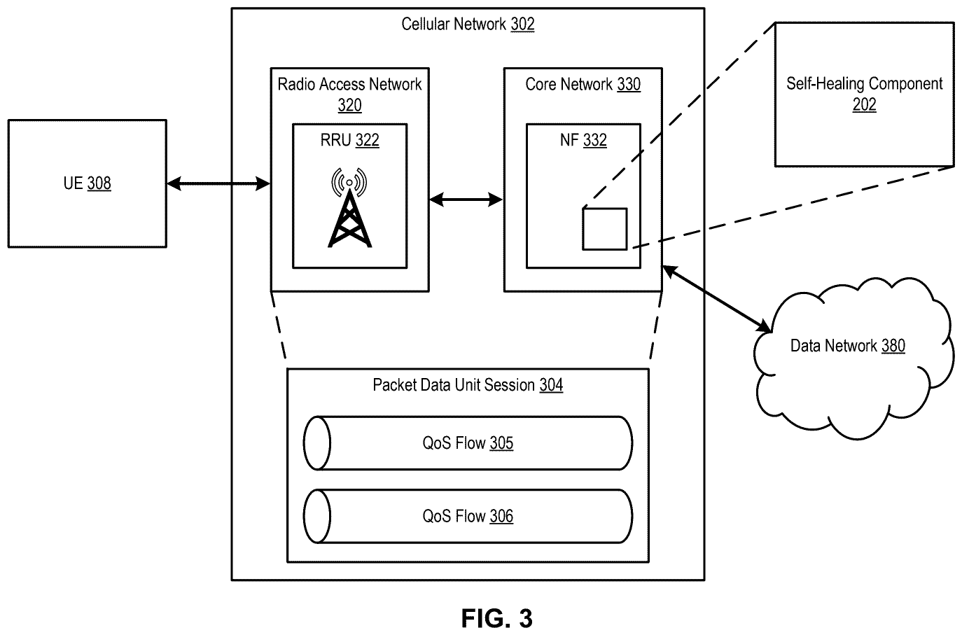

FIG. 3 depicts a cellular network 302 (e.g., a 5G network) including a radio access network (RAN) 320 and a core network 330 configured to generate predictive data for self-healing of network functions, according to some embodiments. In at least one embodiment, the self-healing component 202 of FIG. 2 can be implemented in network 302 to provide self-healing capabilities as described herein. The self-healing component 202 may be executed as part of core network 330. The RAN 320 can include a new-generation radio access network (NG-RAN) that uses the 5G new radio interface (NR). The cellular network 302 connects user equipment (UE) 308 to the data network (DN) 380 using the RAN 320 and the core network 330. The data network 380 can include the Internet, a local area network (LAN), a wide area network (WAN), a private data network, a wireless network, a wired network, or a combination of networks. The UE 308 can include an electronic device with wireless connectivity or cellular communication capability, such as a mobile phone or handheld computing device. In at least one example, the UE 308 can include a 5G smartphone or a 5G cellular device that connects to the RAN 320 via a wireless connection. The UE 308 can include one of a number of UEs not depicted that are in communication with the RAN 320. The UEs may include mobile and non-mobile computing devices. The UEs may include laptop computers, desktop computers, an Internet-of-Things (IoT) devices, and/or any other electronic computing device that includes a wireless communications interface to access the RAN 320.

The RAN 320 includes a remote radio unit (RRU) 322 for wirelessly communicating with UE 308. The remote radio unit (RRU) 322 can include a Radio Unit (RU) and may include one or more radio transceivers for wirelessly communicating with UE 308. The remote radio unit (RRU) 322 may include circuitry for converting signals sent to and from an antenna of a Base Station into digital signals for transmission over packet networks. The RAN 320 may correspond with a 5G radio Base Station that connects user equipment to the core network 330. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 308.

The core network 330 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols, SIP protocols, diameter protocols, and/or APIs. In at least one embodiment, the self-healing component 202 can be implemented in control plane (CP) functions executed by core network 330. In at least one embodiment, an architecture in which software is composed of small independent services that communicate over well-defined APIs may be used for implementing some of the core network functions. For example, control plane (CP) network functions for performing session management may be implemented as containerized applications. A container-based implementation may offer improved scalability and availability over other approaches.

The primary core network functions can include the access and mobility management function (AMF), the session management function (SMF), and the user plane function (UPF), or other functions represented by network function 332. The UPF (e.g., represented as network function 332) may perform packet processing including routing and forwarding, quality of service (QoS) handling, and packet data unit (PDU) session management. The UPF may serve as an ingress and egress point for user plane traffic and provide anchored mobility support for user equipment. For example, the UPF may provide an anchor point between the UE 308 and the data network 380 as the UE 308 moves between coverage areas. The AMF may act as a single-entry point for an UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 320, such as a Distributed Unit (DU) and a centralized unit (CU), may need to be deployed at a cell site or in a local data center (LDC) that is in close proximity to a cell site such that the latency requirements are satisfied (e.g., such that the one-way latency from the cell site to the DU component or CU component is less than 1.2 ms).

In some embodiments, the Distributed Unit (DU) and the centralized unit (CU) of the RAN 320 may be co-located with the remote radio unit (RRU) 322. In other embodiments, the Distributed Unit (DU) and the remote radio unit (RRU) 322 may be co-located at a cell site and the centralized unit (CU) may be located within a local data center (LDC).

The cellular network 302 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the cellular network 302. In some cases, the cellular network 302 may support customized policy configuration and enforcement between network slices per service level agreements (SLAs) within the radio access network (RAN) 320. User equipment, such as UE 308, may connect to multiple network slices at the same time (e.g., eight different network slices). In one embodiment, a PDU session, such as PDU session 304, may belong to only one network slice instance.

In some cases, the cellular network 302 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents. Operations of self-healing component 202 may be executed based on cloud computing resources.

The core network 330 may include a set of network elements that are configured to offer various data and telecommunications services to subscribers or end users of user equipment, such as UE 308. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The cellular network 302 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 3, the core network 330 includes a network function 332 (e.g., a UPF) for transporting IP data traffic (e.g., user plane traffic) between the UE 308 and the data network 380 and for handling packet data unit (PDU) sessions with the data network 380. The UPF can include an anchor point between the UE 308 and the data network 380. The UPF may be implemented as a software process or application running within a virtualized infrastructure or a cloud-based compute and storage infrastructure. The cellular network 302 may connect the UE 308 to the data network 380 using a PDU session 304, which can include part of an overlay network.

The PDU session 304 may utilize one or more quality of service (QoS) flows, such as QoS flows 305 and 306, to exchange traffic (e.g., data and voice traffic) between the UE 308 and the data network 380. The one or more QoS flows can include the finest granularity of QoS differentiation within the PDU session 304. The PDU session 304 may belong to a network slice instance through the cellular network 302. To establish user plane connectivity from the UE 308 to the data network 380, an AMF that supports the network slice instance may be selected and a PDU session via the network slice instance may be established. In some cases, the PDU session 304 may be of type IPv4 or IPv6 for transporting IP packets. The RAN 320 may be configured to establish and release parts of the PDU session 304 that cross the radio interface.

The RAN 320 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 308, over a geographic area. Some cells may correspond with stationary coverage areas and other cells may correspond with coverage areas that change over time (e.g., due to movement of a mobile RRU).

In some cases, the UE 308 may be capable of transmitting signals to and receiving signals from one or more RRUs within the network of cells over time. One or more cells may correspond with a cell site. The cells within the network of cells may be configured to facilitate communication between UE 308 and other UEs and/or between UE 308 and a data network, such as data network 380. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

A UPF represented as network function 332 may be responsible for routing and forwarding user plane packets between the RAN 320 and the data network 380. Uplink packets arriving from the RAN 320 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 320 and the UPF.

The UPF may remove the packet headers belonging to the GTP tunnel before forwarding the user plane packets towards the data network 380. As the UPF may provide connectivity towards other data networks in addition to the data network 380, the UPF must ensure that the user plane packets are forwarded towards the correct data network. Each GTP tunnel may belong to a specific PDU session, such as PDU session 304. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network 380 are mapped onto a specific QoS flow belonging to a specific PDU session before forwarded towards the appropriate RAN 320. A QoS flow may correspond with a stream of data packets that have equal quality of service (QoS). A PDU session may have multiple QoS flows, such as the QoS flows 305 and 306 that belong to PDU session 304. The UPF may use a set of service data flow (SDF) templates to map each downlink packet onto a specific QoS flow. The UPF may receive the set of SDF templates from a session management function (SMF) during setup of the PDU session 304. The SMF may generate the set of SDF templates using information provided from a policy control function (PCF). The UPF may track various statistics regarding the volume of data transferred by each PDU session, such as PDU session 304, and provide the information to an SMF.

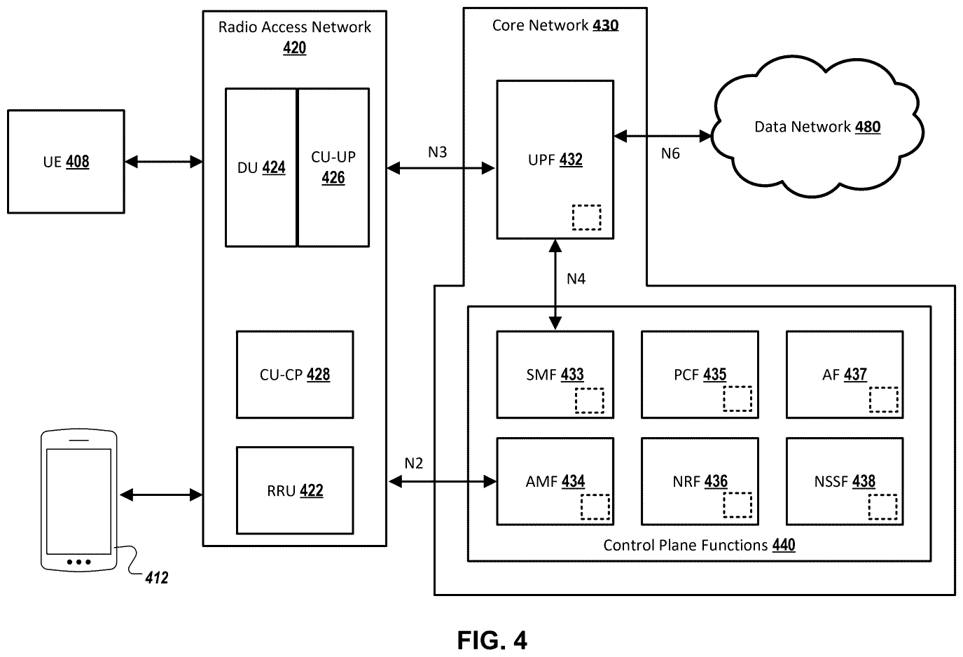

FIG. 4 depicts a RAN 420 and a core network 430 for providing a communications channel (or channel) between user equipment and data network 480, including a self-healing component, according to at least one embodiment. In at least one embodiment, the self-healing component 202 may be implemented in one or more network functions of the core network 430, represented by dashed boxes in various network functions, as described herein. The communications channel can include a pathway through which data is communicated between the UE 408 and the data network 480. The user equipment in communication with the RAN 420 includes UE 408, and mobile computing device 412. The user equipment may include a set of electronic devices, including mobile computing device and non-mobile computing device.

The core network 430 includes network functions such as an access and mobility management function (AMF) 434, a session management function (SMF) 433, and a user plane function (UPF) 432. The core network 430 further includes policy control function (PCF) 435, network repository function (NRF) 436, application function (AF) 437, and network slice selection function (NSSF) 438. Other network functions may also be applicable to aspects of the present disclosure. The AMF may interface with user equipment and act as a single-entry point for a UE connection. The AMF may interface with the SMF to track user sessions. The AMF may interface with a network slice selection function (NSSF 438) to select network slice instances for user equipment, such as UE 408. When user equipment is leaving a first coverage area and entering a second coverage area, the AMF may be responsible for coordinating the handoff between the coverage areas whether the coverage areas are associated with the same radio access network or different radio access networks.

In some embodiments, the SMF 433 may query the NRF 436 to identify a set of available UPFs for a packet data unit (PDU) session and acquire UPF information from a variety of sources, such as the AMF 434 or the UE 408. The UPF information may include a location of the UPF 432, a location of the UE 408, and/or mobile computing device 412, etc., the UPF's dynamic load, the UPF's static capacity among UPFs supporting the same data network, and the capability of the UPF 432.

The UPF 432 may transfer downlink data received from the data network 480 to user equipment, such as UE 408, via the RAN 420 and/or transfer uplink data received from user equipment to the data network 480 via the RAN 420. An uplink can include a radio link though which user equipment transmits data and/or control signals to the RAN 420. A downlink can include a radio link through which the RAN 420 transmits data and/or control signals to the user equipment.

The RAN 720 may be logically divided into a remote radio unit (RRU) 422, a Distributed Unit (DU) 424, and a centralized unit (CU) that is partitioned into a CU user plane portion (CU-UP) 426 and a CU control plane portion (CU-CP) 428. The CU-UP 426 may correspond with the centralized unit for the user plane and the CU-CP 428 may correspond with the centralized unit for the control plane. The CU-CP 428 may perform functions related to a control plane, such as connection setup, mobility, and security. The CU-UP 426 may perform functions related to a user plane, such as user data transmission and reception functions.

Decoupling control signaling in the control plane from user plane traffic in the user plane may allow the UPF 432 to be positioned in close proximity to the edge of a network compared with the AMF 434. As a closer geographic or topographic proximity may reduce the electrical distance, this means that the electrical distance from the UPF 432 to the UE 408 may be less than the electrical distance of the AMF 434 to the UE 408. The RAN 420 may be connected to the AMF 434, which may allocate temporary unique identifiers, determine tracking areas, and select appropriate policy control functions (PCFs) for user equipment, via an N2 interface. The N3 Interface may be used for transferring user data (e.g., user plane traffic) from the RAN 420 to the user plane function UPF 432 and may be used for providing low-latency services using edge computing resources. The electrical distance from the UPF 432 (e.g., located at the edge of a network) to user equipment, such as UE 408, may impact the latency and performance services provided to the user equipment.

The UE 408 may be connected to the SMF 433 via an N1 interface not depicted, which may transfer UE information directly to the AMF 434. The UPF 432 may be connected to the data network 480 via an N6 interface. The N6 interface may be used for providing connectivity between the UPF 432 and other external or internal data networks (e.g., to the Internet). The RAN 420 may be connected to the SMF 433, which may manage UE context and network handovers between Base Stations, via the N2 interface. The N2 interface may be used for transferring control plane signaling between the RAN 420 and the AMF 434.

The RRU 422 may perform physical layer functions, such as employing orthogonal frequency-division multiplexing (OFDM) for downlink data transmission. In some cases, the DU 424 may be located at a cell site (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different cell sites (or cellular Base Stations) and 180 different RRUs.

In some embodiments, the RAN 420 or portions of the RAN 420 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 424 and CU-UP 426 may be executed as virtual instances within a data center environment that provides single-digit millisecond latencies (e.g., less than 2 ms) from the virtual instances to the UE 408.

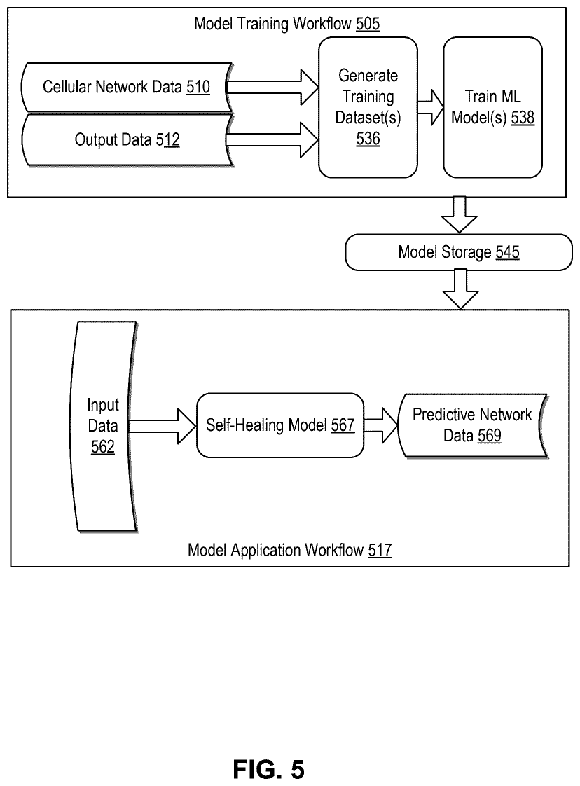

FIG. 5 illustrates a model training workflow 505 and a model application workflow 517 for cellular network data in connection with self-healing network function operations, in accordance with some embodiments of the present disclosure. In embodiments, the model training workflow 505 may be performed at a server or processing device which may or may not be included in architecture of a cellular network (e.g., a computing device of a 5G network executing a software defined data pipeline control module), and the trained models are provided to an edge computing device proximate one or more components of the network, which may perform the model application workflow 517. In some embodiments, one or more network functions may execute one or more of model training workflow 505 or model application workflow 517. The model training workflow 505 and the model application workflow 517 may be performed by processing logic executed by a processor of a computing device. One or more of these workflows 505, 517 may be implemented, for example, by one or more machine learning modules implemented by components of self-healing system 100 of FIG. 1, e.g., network server device 102.

In one embodiment, the trained machine learning model is a decision tree, a random forest model, a support vector machine, or other type of machine learning model.

In one embodiment, the trained machine learning model is an artificial neural network (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

In some embodiments, a model (e.g., a self-healing model) may be implemented as a rule-based model, with capability to be adjusted or updated subject to feedback on operations of the model. The trained machine learning model may be periodically or continuously retrained to achieve continuous learning and improvement of the trained machine learning model. The model may generate an output based on an input, an action may be performed based on the output, and a result of the action may be measured. In some instances, the result of the action is measured within seconds or minutes, and, in some instances, it takes longer to measure the result of the action. For example, one or more additional processes may be performed before a result of the action can be measured. The action and the result of the action may indicate whether the output was a correct output and/or a difference between what the output should have been and what the output was. Accordingly, the action and the result of the action may be used to determine a target output that can be used as a label for the measurements. Once the result of the action is determined, the input (e.g., error data), the output of the trained machine learning model (e.g., recommended corrective actions), and the target result (e.g., correction of a condition of the cellular network not satisfying a target threshold) actual measured result (e.g., measured condition of the network) may be used to generate a new training data item. The new training data item may then be used to further train the trained machine learning model. This retraining process may be performed by components of a software defined cellular network in embodiments.

The model training workflow 505 is to train one or more machine learning models (e.g., deep learning models) to perform one or more classifying, segmenting, detection, recognition, decision, etc., tasks associated with a cellular network. The model application workflow 517 is to apply the one or more trained machine learning models to perform the classifying, segmenting, detection, recognition, determining, etc. tasks for generating predictive data in association with the cellular network, such as recommended corrective actions, data to generate insights or key performance indicators, etc.

Various machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In embodiments, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are as follows:
a. Generation of recommended corrective actions based on error codes—In some embodiments, self-healing model may receive error codes related to communication interfaces of a network function. The self-healing model may generate recommendations for updating operations of the cellular network to improve network performance.
b. Enacting corrective actions—In some embodiments, the self-healing model may perform actions based on error codes or other input, e.g., actions internal to the network function associated with the self-healing model. For example, the network function may take itself offline, direct traffic or data communication from the network function to a particular other function, other component, or the like, reduce availability or bandwidth of the network function based on reduced hardware capabilities, or the like.
c. Providing of predictive data—In some embodiments, the self-healing model may provide data indicative of network performance to other network functions. For example, the self-healing model may provide indications that one or more interfaces, devices, components, or functions are performing at a reduced capacity, and may provide indications to enable a central control module to update network parameters, to instruct a network repository function to deregister one or more components of the network, or the like

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

For the model training workflow 505, a training dataset containing hundreds, thousands, tens of thousands, hundreds of thousands or more cellular network data 510 (e.g., combinations of error codes or status codes, contextual data, error frequency data, etc.) should be used to form a training dataset. In embodiments, the training dataset may also include associated outcome data 512 (e.g., associated key performance indicator values, associated corrective actions, associated data to transfer to a central module or another network function, etc.) for forming a training dataset, where each data point and/or associated configuration may include various labels or classifications of one or more types of useful information. This data may be processed to generate one or multiple training datasets 536 for training of one or more machine learning models.

To effectuate training, processing logic inputs the training dataset(s) 536 into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the cellular network data 510 and output data 512 into the machine learning model one at a time. In some embodiments, the training of the machine learning model includes tuning the model to receive cellular network data 510 and output predictive data (e.g., predictions of network performance). The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

Accordingly, the output may include one or more predictions or inferences. For example, an output prediction or inference may include summary data, indications of cellular network performance, or the like. Processing logic may cause one or more updates to the cellular network based on the output. Processing logic may provide summary data to one or more northbound applications. Processing logic may provide requests for summary data to components of the network, such as a software defined data pipeline control module.

Processing logic may compare the generated output against a target output (e.g., a label corresponding to the “correct answer”) and determine whether a threshold criterion is met (e.g., threshold similarity between the generated output and target output). Processing logic determines an error (i.e., a classification error) based on the differences between the generated output and the target output. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria are met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

As an example, in one embodiment, a machine learning model (e.g., self-healing model 567) is trained to determine predictive data (e.g., predicted updates to improve operations of a cellular network). A similar process may be performed to train machine learning models to perform other tasks such as those set forth above. A set of many (e.g., thousands to millions) sets of model input data may be collected and performance indicators may be determined based on the input data.

Once one or more trained machine learning models 538 are generated, they may be stored in model storage 545, and may be added to a cellular network, e.g., a processing device or data storage device associated with a target network function, or the like. The cellular network may then use the one or more trained ML models 538 as well as additional processing logic to implement an automatic mode, in which user manual input of information is minimized or even eliminated in some instances.

For model application workflow 517, according to one embodiment, input data 562 may be input into self-healing model 567, which may include a trained neural network. Based on the input data 562, self-healing model 567 outputs information indicating network performance, recommended corrective actions, enacting corrective actions, or the like. Self-healing model 567 generates predictive network data 569, which may include summary data, recommended actions, summary data requests, predicted root causes, or the like.

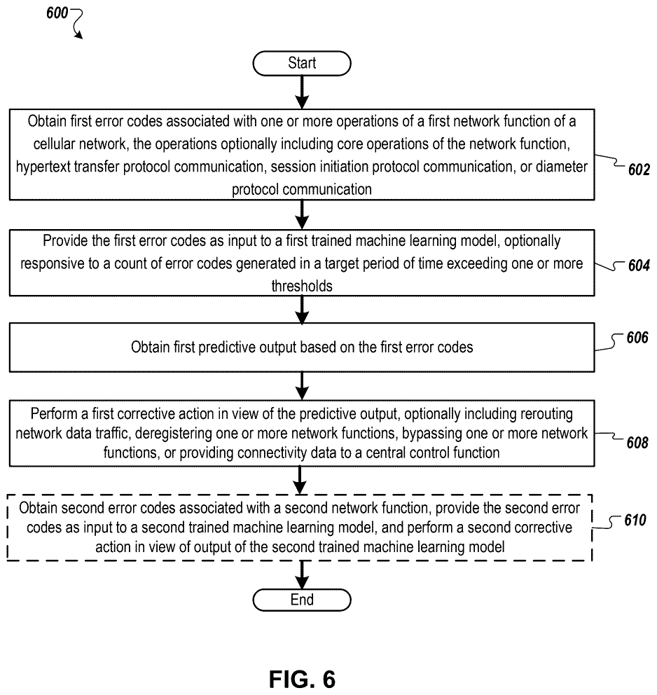

FIG. 6 includes a flow diagram of method 600 associated with self-healing network functions, according to certain embodiments. Method 600 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 600 may be performed, in part, by components of self-healing system 100. Method 600 may be performed by network server device 102 of FIG. 1, etc. In some embodiments, a non-transitory machine-readable storage medium stores instructions that when executed by a processing device (e.g., of network server device 102, of self-healing system 100, etc.) cause the processing device to perform operations of method 600.

For simplicity of explanation, method 600 is depicted and described as a series of operations. However, operations in accordance with this disclosure can occur in various orders and/or concurrently and with other operations not presented and described herein. Furthermore, not all illustrated operations may be performed to implement method 600 in accordance with the disclosed subject matter. In addition, those skilled in the art will understand and appreciate that method 600 could alternatively be represented as a series of interrelated states via a state diagram or events.

FIG. 6 is a flow diagram of a method 600 for performing corrective actions based on network function error codes, according to some embodiments. At block 602, process logic obtains first error codes associated with one or more operations of a first network function of a cellular network. In some embodiments the process logic may instead or additionally receive one or more status indicators, e.g., an indicator that no error has occurred, that an amount of network traffic has been provided to a component, or the like. In some embodiments, context or other accompanying data may be provided. In some embodiments, the operations associated with the status codes, error codes, or the like may include core operations of the network function, HTTP communication, SIP communication, or diameter communication.

At block 604, process logic provides the first error codes as input to a first trained machine learning model, optionally responsive to a count of error codes generated in a target people of time exceeding one or more thresholds. In some embodiments the first trained machine learning model may be executed on the same (physical or virtual) computing device as the operations of method 600, as operations of the first network function, or the like. In some embodiments, the first trained machine learning model may be executed by a central control function or central device of the cellular network, e.g., separate from the first network function. For example, error codes, status updates, or the like may be provided to a central model, which may generate predictive or corrective outputs based on input from multiple network functions. In some embodiments, predictive outputs of trained machine learning models of one or more network functions may be provided to a central machine learning model, for further predictive and/or corrective data to be generated by the central machine learning model.

At block 606, process logic obtains first predictive output based on the first error codes. The first predictive output may be obtained from the first trained machine learning model, based on the input data provided to the first trained machine learning model.

At block 608, process logic performs a first corrective action in view of the predictive output. The first corrective action may be determined to improve network performance, network functionality, or the like. The first corrective action may include rerouting network data traffic, deregistering one or more network functions, bypassing one or more network functions, or providing connectivity data to a central control function.

At block 610, process logic optionally performs similar operations as those described above with respect to a second network function, different from the first. Process logic may obtain second error codes associated with a second network function. Process logic may provide the second error codes to a second trained machine learning model. Process logic may obtain output from the second trained machine learning model based on the input error codes. Process logic may perform a second corrective action in view of the output from the second trained machine learning model.

In some embodiments, interfaces between particular network functions may be targeted. For example, status or error codes associated with communication between the first network function and a specific network function of interest may be utilized, optionally along with application function error or status updates, to determine health of the first network function in relation to the target network function. In some embodiments, operations of the PCF with respect to the NRF may be targeted. In some embodiments, operations of the PCF with respect to the SMF may be targeted. In some embodiments, operations of the NRF with respect to the PCF may be targeted. In some embodiments, operations of the SMF with respect to the PCF may be targeted.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method, comprising:
obtaining, by a processing device, first error codes associated with one or more operations of a first network function of a cellular network;
providing the first error codes as input to a first trained machine learning model;
obtaining, from the first trained machine learning model, first predictive output based on the first error codes; and
performing a first corrective action in view of the first predictive output.

2. The method of claim 1, wherein the operations comprise one or more of:
core operations of the first network function;
hypertext transfer protocol communication;
session initiation protocol communication; or
diameter protocol communication.

3. The method of claim 1, wherein the first network function comprises one or more of:
a network repository function;
a session management function;
a policy control function;
a network slice selection function;
an authentication server function;
a network exposure function;
an access and mobility management function; or
a user plane function.

4. The method of claim 1, further comprising:
obtaining second error codes associated with a second network function, different than the first network function;
providing the second error codes as input to a second trained machine learning model; and
performing a second corrective action in view of second predictive output of the second trained machine learning model in association with the second network function.

5. The method of claim 1, wherein the first error codes are provided to the first trained machine learning model responsive to a count of error codes received in a target period of time exceeding a first threshold of a plurality of thresholds, each threshold associated with a different duration of time.

6. The method of claim 1, wherein the first corrective action comprises one or more of:
rerouting network data traffic;
deregistering one or more network functions;
bypassing one or more network functions; or
providing connectivity data to a central control function.

7. The method of claim 1, wherein the first trained machine learning model is included as a component of the first network function, and the processing device is configured to execute the first network function.

8. The method of claim 1, wherein the first trained machine learning model is executed by a central control function associated with a core network of the cellular network.

9. One or more non-transitory, computer-readable storage media having computer-readable instructions thereon which, when executed by one or more processing devices, cause the one or more processing devices to perform operations comprising:
obtaining first error codes associated with one or more operations of a first network function of a cellular network;
providing the first error codes as input to a first trained machine learning model;
obtaining, from the first trained machine learning model, first predictive output based on the first error codes; and
performing a first corrective action in view of the first predictive output.

10. The one or more non-transitory, computer-readable storage media of claim 9, wherein the operations of the first network function comprise one or more of:
core operations of the first network function;
hypertext transfer protocol communication;
session initiation protocol communication; or
diameter protocol communication.

11. The one or more non-transitory, computer-readable storage media of claim 9, wherein the first network function comprises one or more of:
a network repository function;
a session management function;
a policy control function;
a network slice selection function;
an authentication server function;
a network exposure function;
an access and mobility management function; or
a user plane function.

12. The one or more non-transitory, computer-readable storage media of claim 9, wherein the operations performed by the one or more processing devices further comprise:
obtaining second error codes associated with a second network function, different than the first network function;
providing the second error codes as input to a second trained machine learning model; and
performing a second corrective action in view of second predictive output of the second trained machine learning model in association with the second network function.

13. The one or more non-transitory, computer-readable storage media of claim 9, wherein the first error codes are provided to the first trained machine learning model responsive to a count of error codes received in a target period of time exceeding a first threshold of a plurality of thresholds, each threshold associated with a different duration of time.

14. The one or more non-transitory, computer-readable storage media of claim 9, wherein the first corrective action comprises one or more of:
rerouting network data traffic;
deregistering one or more network functions;
bypassing one or more network functions; or
providing connectivity data to a central control function.

15. The one or more non-transitory, computer-readable storage media of claim 9, wherein the first trained machine learning model is included as a component of the first network function, and the processing device is configured to execute the first network function.

16. A system comprising memory and a processing device coupled to the memory, wherein the processing device is configured to:
obtain error codes associated with one or more operations of a network function of a cellular network;
provide the error codes as input to a trained machine learning model;
obtain, from the trained machine learning model, predictive output based on the error codes; and
perform a corrective action in view of the predictive output.

17. The system of claim 16, wherein the operations comprise one or more of:
core operations of the network function;
hypertext transfer protocol communication;
session initiation protocol communication; or
diameter protocol communication.

18. The system of claim 16, wherein the network function comprises one or more of:
a network repository function;
a session management function;
a policy control function;
a network slice selection function;
an authentication server function;
a network exposure function;
an access and mobility management function; or
a user plane function.

19. The system of claim 16, wherein the error codes are provided to the trained machine learning model responsive to a count of error codes received in a target period of time exceeding a first threshold of a plurality of thresholds, each threshold associated with a different duration of time.

20. The system of claim 16, wherein the corrective action comprises one or more of:
rerouting network data traffic;
deregistering one or more network functions;
bypassing one or more network functions; or
providing connectivity data to a central control function.
